(19) United States
(12) Patent Application Publication
(10) Pub. No.: US 2008/0134894 A1
(43) Pub. Date: Jun. 12, 2008

(54) Parallel plate denuder for gas absorption

(75) Inventors: Chuen-Jinn Tsai, Hsinchu City (TW); Guan-Yu Lin, Zhonghe City (TW)

Correspondence Address: BUCKNAM AND ARCHER, 1077 NORTHERN BOULEVARD, ROSLYN, NY, 11576, US

(73) Assignee: National Chiao Tung University, Hsinchu (TW)

(21) Appl. No.: 11/708,512

(22) Filed: Feb. 20, 2007

(30) Foreign Application Priority Data
Dec. 6, 2006 (TW) 095145347

(51) Int. Cl. B01D 53/22

(52) U.S. Cl. 96/5

(57) ABSTRACT

This invention provides a high-efficiency parallel plate wet denuder (PPWD) for gas absorption, the absorption surfaces thereof are composed of two hydrophilic porous glass plates on which TiO₂ particles are coated and subsequently are irradiated with UV light to form super-hydrophilic surfaces, so that it further enhances the formation of uniform water film and increases gas absorption efficiency. This invention can be used in the manual sampling devices for acidic/basic gases, the gas absorption equipments for acidic/basic gases and gas-particle denuder sampling devices, besides it can also be coupled with an ion chromatograph to make semi-continuous acidic/basic gas-particle monitors.

### FIELD OF THE INVENTION

This invention relates to the fields of environmental science, and particularly to the development of a semi-continuous and/or continuous sampling apparatus which requires enough convenience in operation and high precision for analysis task.

### BACKGROUND OF THE INVENTION

Acidic/basic solutions are usually used in etching process for manufacturing wafer/chip of semiconductor or optic-electron devices, and simultaneously, some unavoidable pollutants are emitted because of direct or indirect exhaust gases while handling acidic/basic solutions, such as hydrogen fluoride, hydrogen chloride, nitric acid, sulfuric acid and ammonia, etc. which are harmful to human health and may cause illness after long-term exposure. Thus, the Taiwan Environment Protection Administration has accordingly drafted and enacted many regulations to govern the air pollutants from such kinds of plants, for examples, the pollutant removal efficiency of the control device should be at least 95%, the emission rate of any one of hydrogen fluoride, nitric acid, hydrogen chloride and phosphoric acid should be less than 0.6 kg/hr, and that of sulfuric acid should be less than 0.1 kg/hr.

Regarding the measurement of emission rate or gas concentration of the above-mentioned acidic/basic flue gases, Tsai, et al., had reported that in the papers, “Design and testing of a personal porous metal denuder, Aerosol Science Technology, 35, 611-616, 2001” and “Comparison of Collection Efficiency and Capacity of Three Acidic Aerosol Samplers, Environment Science Technology, 35, 2572-75, 2001”, describing a design of porous metal denuder, and comparing with silica gel tube and absorption flask for gas absorption efficiency. The denuder of Tsai is made of Teflon material, including two inertial impactors which are capable of collecting some particulates with two dynamic diameters of 9.5 μm and 2.0 μm respectively, a filter paper required to collect particulates smaller than a dynamic diameter of 2.0 μm and two porous metals for removing inorganic acidic/basic gases, such as HNO₃, HCl, HF and NH₃; wherein the filter paper and porous metals are in series at the downstream of the denuder. Furthermore, in 2004, the Taiwan Environmental Protection Administration adopted the results studied by Tsai and Huang, “Study on the method for measuring hydrogen fluoride, nitric acid and phosphoric acid” funded by the Taiwan Environmental Protection Administration in 2003, as a standard reference method, NIEA A452.70B, “sampling and analysis method for HF, HNO₃, HCl, H₃PO₄, H₂SO₄ in the exhaust duct—isokinetic sampling method”; wherein the reference method is that, the denuder prepared after the porous metal denuder is coated with 5% Na₂CO₃ solution and then is used to sample the exhaust acidic gas using the isokinetic sampling method. The samples are taken from the exhaust duct to the laboratory where the porous metal denuder is extracted using ultra-pure water and the concentrations of samples are analyzed using ion chromatograph.

The above-mentioned sampling and analysis process is very complicated and may cause some deviations due to improper operation. Furthermore, the sampling time that requires at least 30 minutes in exhaust duct and 12 hours at the periphery of the factory is not suitable for the circumstance where the concentration of sampling gas fluctuates.

In order to improve the above-mentioned sampling method, some continuous wet denuders have been developed, for example, a wet denuder (as shown in FIG. 1) published in Willeke and Baron's book, “Aerosol Measurement, Van Nostrand Reinhold: New York, Chapter 19, pp 435-440, 2001”, in which the body constitutes a glass tube with an inner semi-permeable tube 08. Such denuder has two different types. In the first type, the flue gas flows through the inner semi-permeable tube 08 and the countercurrent scrubbing liquid flows upwards around the inner tube. The flue gas is absorbed by the scrubbing liquid along the intermediate membrane (shown in FIG. 1A). In the second type, the scrubbing liquid flows through the inner semi-permeable tube 08 while the co-current flue gas flows downwards around the inner tube, and the flue gas is absorbed by the scrubbing liquid along the intermediate membrane (shown in FIG. 1B).

Simon et al. published four kinds of automated wetted annular denuders (as shown in FIGS. 2A˜2D) in “Wet Effluent Denuder Coupled Liquid/Ion Chromatography System, Anal. Chem., 63, pp. 1237-42, 2001”, the four wet denuder designs are internally threaded glass-filled PTFF denuder(FIG. 2A), polyethylene membrane-lined denuder(FIG. 2B), polycarbonate membrane-lined denuder (FIG. 2C) and silicate-coated denuder(FIG. 2D ), respectively, wherein the silicate-coated denuder has the best wettability and sampling efficiency. These kinds of denuders have the advantages that the coated porous metal is replaced by continuous liquid film to avoid man-made pollution, and the scrubbing liquid is suitable for various gases.

Furthermore, in another paper of Simon and Dasgupta, “Wet Effluent Denuder Coupled Liquid/Ion Chromatography System/Annual and Parallel Plate, Anal. Chem., 65, pp. 1134-1139, 1993”, where a parallel plate wet denuder (PPWD) shown in FIG. 3 includes two glass-made parallel plates as absorption surfaces. The plates are coated with a SiO₂ layer as hydrophilic material. The dimensions of the absorption surfaces are 600 mm in height and 36 or 50 mm in width; the distance between the parallel plates is 3 mm. The experiment is carried out using SO₂ as the target gas, sampling flow rate is maintained at 10 L/min., scrubbing liquid is 0.5 m M H₂O₂ and is at a flow rate of 265 μL/min.;

In the article of Rosman et al., “Laboratory and Field Investigation of a new Simple Design for the Parallel Plate Denuder, Atmosphere Environment, 35, pp. 5301-5310, 2001”, it is reported that in ambient, sampling operation using the parallel plate wet denuder coated with SiO₂, oily organic gas absorbed on the surface affected the hydrophilic property of the surface, which can't be recovered even after detergent is used to clean the surface.

### SUMMARY OF INVENTION

The objective of the present invention is to provide a high-efficiency parallel plate wet denuder which can eliminate the problems of gas sampling in flue gas using the standard reference method, provide the convenience in operation and increase the precision for sampling and analysis.

The wet denuder of the present invention as shown in FIG. 4A comprises a body made of two symmetrical acrylic plates. FIG. 4B shows the left portion of the present denuder, which is symmetrical to the right portion in structure and components, and both of them are made of the same material. A channel for gas flow is formed after the two plates are assembled together, as shown in FIG. 4A. Continuous uniform water film flowing downward from the top of the glass plates absorbs gas which flows upwards. Each half of the denuder comprises an acrylic body 1 with a porous glass plate 2 thereon. There are two water reservoirs positioned on the top and bottom of the acrylic body 1 and are used as a liquid overflow reservoir 4 and a liquid collection reservoir 5, respectively. A porous metal is arranged at the exit of the liquid overflow reservoir 4 which turns the overflow liquid into a uniform water flow. Water subsequently flows through a porous glass plate 2 with super-hydrophilic property to form a very uniformly falling water film. Gas is absorbed by the falling water film along its continuous and uniform surface while it is flowing upwards from the entry of channel, i.e., the bottom side of the acrylic body 1, and then the cleaned gas exits the channel, i.e., the upper side of the acrylic body 1. The liquid absorbing the pollutants flows through the entry of the liquid reservoir 5 which is located at the bottom side of the acrylic body 1 and is collected in the bottom liquid reservoir. After a fixed time, the liquid sample in the collection reservoir 5 is pumped into the ion chromatography by peristaltic pump, or sampled by a measuring flask to analyze the liquid sample manually.

The size and depth of the pores distributed on the surface of porous glass plate according to the present invention can be controlled by sandblasting process so that the falling water film flowing along the active surface keeps uniform and well-distributed. Furthermore, the active surface of the porous glass 2 is coated with TiO₂ nanoparticles and irradiated by UV light from the rear side of the porous glass plate to enhance the superhydrophilicity of the porous glass surface due to photocatalytic activity. Particularly, the porous glass surface coated with TiO₂ nanoparticles can be irradiated by UV light to oxidize the residual organic materials on the glass surface after operating a period of time, the superhydrophilicity of the porous glass surface can be recovered by means of photocatalytic activity.

### BRIEF DESCRIPTION OF DRAWINGS

FIG. 1 is two schematic drawings of wet denuders of Willeke and Baron; wherein, FIG. 1A and FIG. 1B show different flow patterns of gas and liquid respectively.

FIG. 2 is four schematic drawings of different types of annular denuders of Simon et al., wherein, FIG. 2A: internally threaded glass-filled PTFE denuder; FIG. 2B: wetted membrane-lined denuder; FIG. 2C: porous-wall denuder; FIG. 2D: silica-coated denuder.

FIG. 3 is a schematic drawing of wet parallel plate denuder of Simon and Dasgupta, wherein, the grey section is the active surface which is coated with TiO₂.

FIG. 4 is a schematic drawing and its components in view of the present denuder, wherein, FIG. 4A shows the constitution of parallel plate; FIG. 4B shows the front view and side view of the denuder.

FIG. 5 is a schematic of experimental setup for gas absorption efficiency, in which the experiment is conducted by using the denuder according to the present invention.

FIG. 6 is a graph showing the result of HF gas absorption efficiency experiment versus sampling flow rate of 5 L/min, in which the experiment is conducted by using the denuder according to the present invention with smooth glass plate as absorption surface coated with TiO₂ nanoparticles and irradiated with UV light.

FIG. 7 is a graph showing the results of HF gas absorption efficiency experiment versus sampling flow rate of 5 L/min., 7 L/min. and 10 L/min., in which the experiment is conducted by using the denuder according to the present invention with porous glass plate as absorption surface coated with TiO₂ and irradiated with UV light for 2 hours.

FIG. 8 shows the results of another embodiment of HCL gas absorption efficiency versus gas flow rate using the denuder according to the present invention under the conditions, gas flow rate, respectively: 5 L/min., 7 L/min., 8 L/min. and 10 L/min., absorption surface: porous glass plate with TiO₂ coating and 2-hour UV light irradiation.

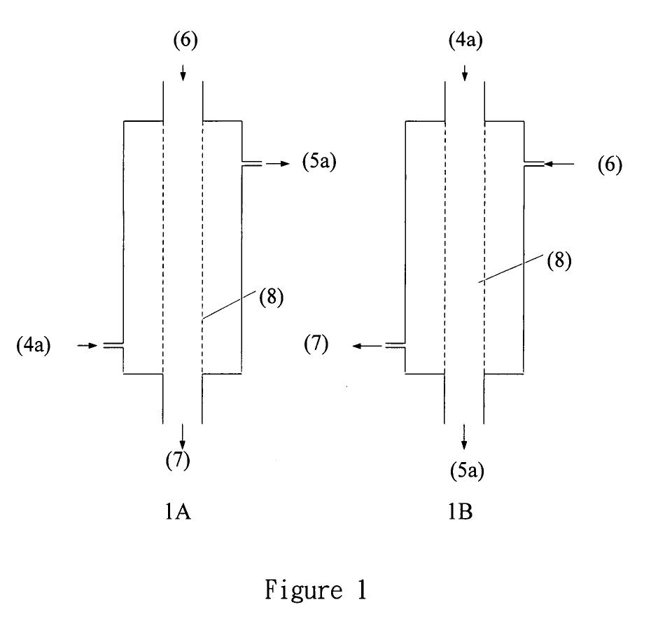

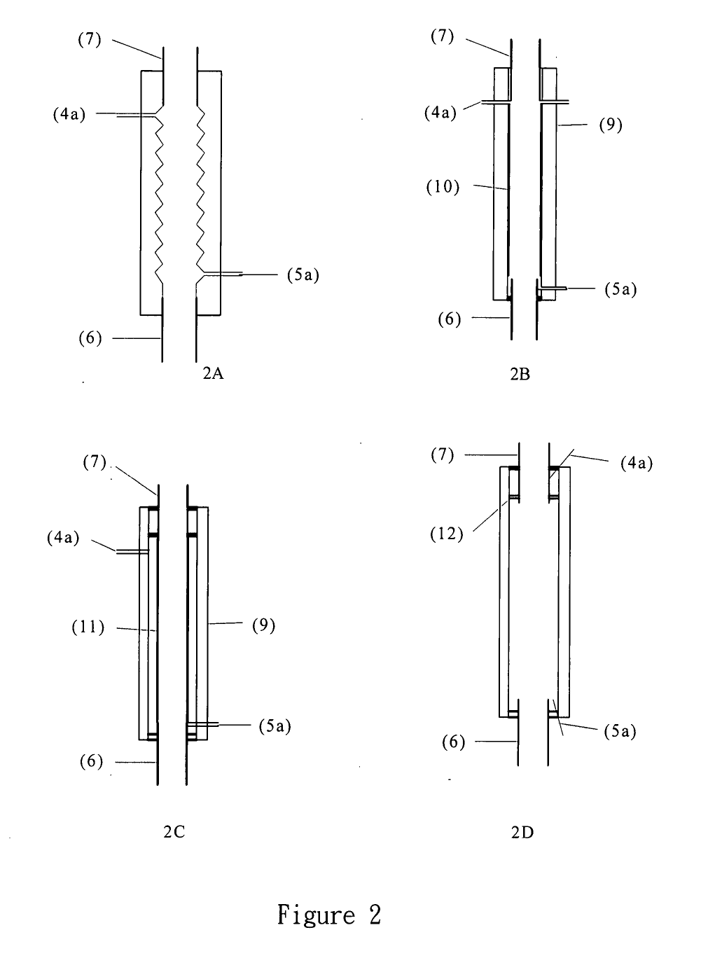

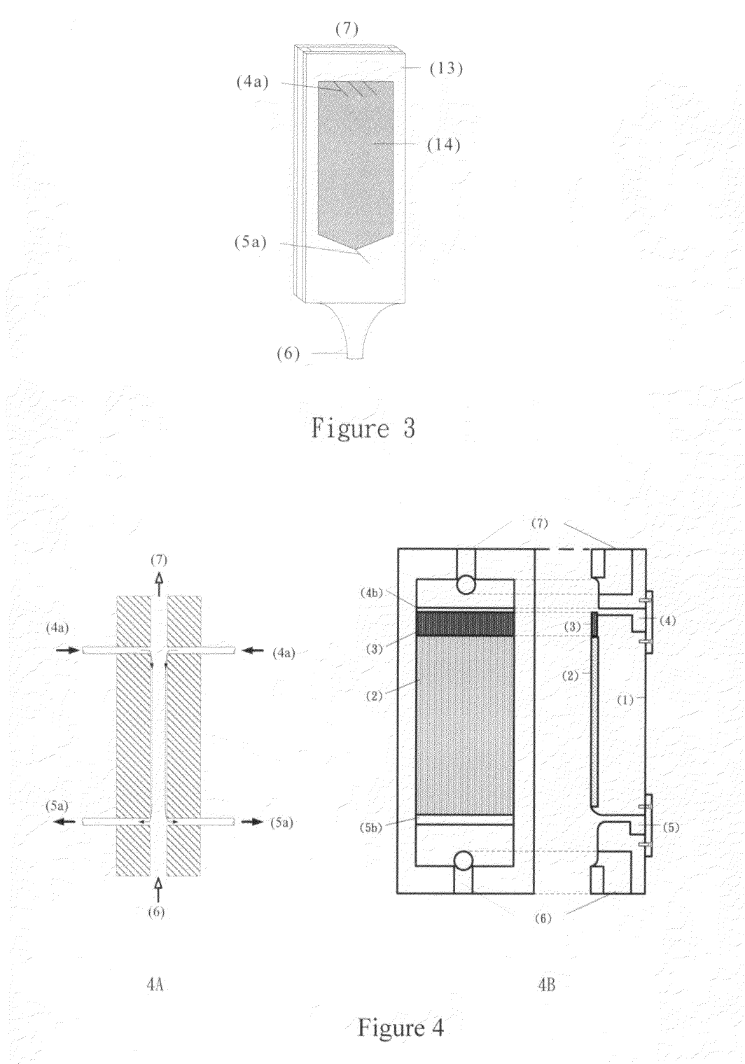

### DETAILED DESCRIPTION OF PREFERRED EMBODIMENTS

In the text which follows, the invention is described by way of example on the basis of the following exemplary embodiments:

[Apparatus]

The parallel plate wet denuder according to the present invention comprises two separated plates which are made of acrylic material, with 2.5 cm in thickness and 4 mm in width of gap between them. The two plates are connected by stainless steel screw, and sealed with silica gel to prevent gas leakage. The absorption surface with area of 112.5 cm² is made of porous glass plate and coated with TiO₂ thin film.

The processes for preparing TiO₂ thin film on the glass plate surface are shown as following list: (1) 0.5 g of TiO₂ nanoparticles (P25, Degussa) and 50-ml ultra-pure water are poured into a beaker, then the solution is continuously stirred with a magnetic stone for 10 min. (2) the mixed solution is subsequently poured onto porous glass surface and laid steadily. After 30 min., the glass plate is heated to 300° C. for 2 hours. (3) The treated glass plates are cooled down at room temperature. Thus good wettability of the glass plates is achieved while the coated TiO₂ nanoparticles are adhered to the plates firmly. (4) The glass plate been treated with TiO₂ coating shall be fixed with silica gel on an acrylic plate. There is a little reservoir on the top of the denuder which makes the distribution of the liquid smoothly while continuous supplying liquid is overflowing from the reservoir. Wherein the uniform liquid film on the glass surface can be achieved due to its super-hydrophilic property after the absorption surface is treated by the foregoing process.

[Gas Absorption]

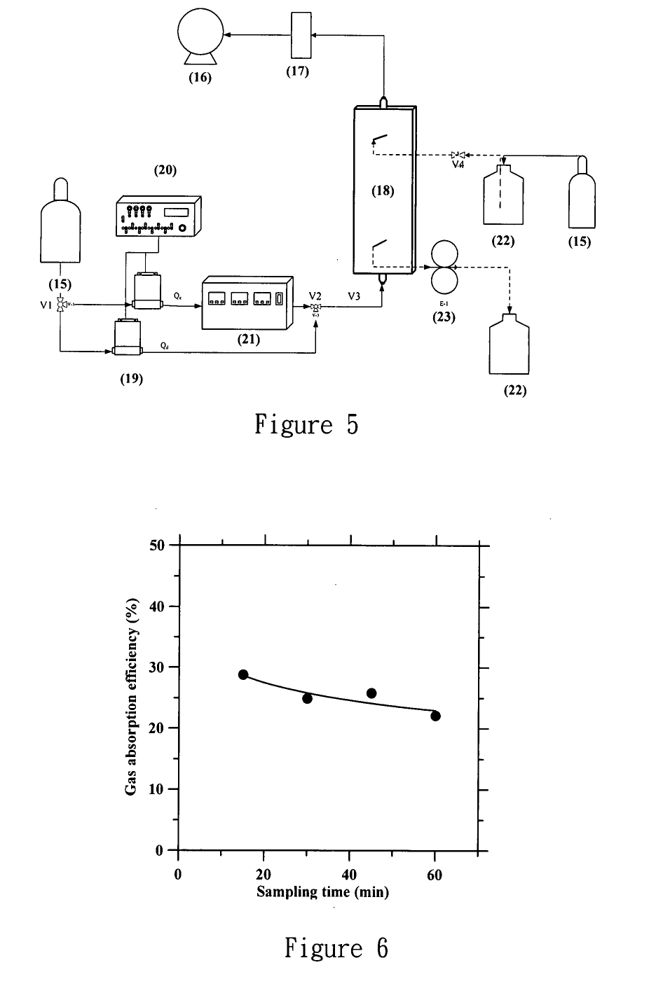

The gas absorption efficiency experiment is carried out by PPWD for sampling and analyzing acidic gases under various conditions, such as gas flow rates, different categories of gas, etc. The experiment setup is shown in FIG. 5.

1. Gases:

High purity nitrogen gas 12 is used as dilution gas and carrier gas and the pipeline for transferring gases are made of Teflon. First of all, the nitrogen gas is distributed into two streams via a three-way control valve V1; one stream is used as the carrier gas (Q_{c}) and flows into the permeation tube and oven 19. The other stream is used as dilution gas (Q_{d}) to dilute the standard gas. The flow rates of these two streams are adjusted by a mass flow rate controller (MKS). Finally, the standard gas with known concentration is introduced into the parallel plate wet denuder 16 for testing gas absorption efficiency experiment. The gas absorption efficiency of the PPWD for HF and HCl can be confirmed by the procedure as has been mentioned above.

2. Liquid:

Ultra-pure water with pH=7.0, is used as the absorption liquid according to the exemplary embodiment. The absorption liquid stored in a high pressure scrubbing solution container 21 is pushed by the nitrogen gas 12 into the denuder via pipeline. The absorption liquid flow rate is adjusted to 1 cc/min by a needle valve V4. The absorption liquid flows downward along the porous glass plate surface to the bottom of the denuder where the absorption liquid is pumped out by a peristaltic pump and the ion concentration is analyzed by ion chromatograph.

3. Calculation of Gas Absorption Efficiency

To calculate the concentration of gas absorbed in scrubbing liquid, the following process is performed:

1. Gas permeation rate of the permeation tube (made by VICI Inc.), mi (ng/min.), is incorporated into equation (1) to acquire the standard gas concentration, C_{g} (μg/m³):

$${C}_{g} = \frac{{m}_{i} \times {10}^{- 3}}{{Q}_{t} \times {10}^{- 3}} \qquad ( 1 )$$

where:
C_{g} (μg/m³) is the concentration of standard gas.
mᵢ (ng/min) is permeation rate of the permeation tube.
Q_{c} (1/min) is flow rate of carrier gas.
Q_{d} (1/min) is flow rate of dilution gas.
Qₜ (1/min) (Q_{c}+Q_{d}) is the overall flow rate.

Theoretical value of gas concentration sampled by the parallel plate wet denuder

The theoretical liquid sample concentration sampled by the PPWD can be calculated by equation (2):

$${C}_{I , PPWD , Theory} = \frac{{C}_{g} \times {Q}_{g , PPWD}}{{Q}_{I , PPWD}} \qquad ( 2 )$$

where:
C_{l,PPWD,Theory} (μg/m³) is the theoretical value of liquid sample concentration sampled by the parallel plate wet denuder.
Q_{g,PPWD} (1/min) is the sampling gas flow rate.
Q_{l,PPWD} (1/min) is the actual scrubbing liquid flow rate.

[Calculation of Gas Absorption Efficiency for Parallel Plate Wet Denuder]

(1) The gas absorption efficiency of the parallel plate wet denuder is expressed in equation (3):

$$\frac{{C}_{g , PPWD}}{{C}_{g}} \times 100 \% \qquad ( 3 )$$

### C_{g,PPWD}(μg/m³) could be derived from equation (4):

$${C}_{g , PPWD} = \frac{{C}_{I , PPWD} \times {Q}_{I , PPWD}}{{Q}_{g , PPWD}} \qquad ( 4 )$$

where:
C_{g,PPWD} (μg/m³) is the gas concentration sampled by the parallel plate wet denuder.
C_{l,PPWD,Actual} (μg/m³) is the actual liquid sample concentration sampled by the parallel plate wet denuder.

### [Result and Discussion]

The gas absorption efficiency experiment is conducted to test the collection efficiency of the parallel plate wet denuder for acidic gas with different air sampling flow rate. The influence of wettability of the active surface on gas collection efficiency has also been concerned in all research.

The active surface is made of glass, and two types of glass plate surface are chosen for the present tests, one is the smooth glass plate with TiO₂ coating, the other is the porous glass plate with TiO₂ coating. The experimental results are described according to the two types of active surfaces.

### 1. The Smooth Glass Plates:

Regarding the smooth glass plate as the active surface of the denuder, it is found that the liquid film is not uniform and the sampling efficiency is not as well as expected after sampling time of one hour. As shown in FIG. 6, the sampling efficiency is only 25% when the gas flow rate is 5 L/min. The main reason of the poor efficiency is that the liquid film on the active surface apparently is not uniform, some parts of the active surface are always dry and thus the gas pollutants will penetrate through the PPWD due to channeling effect.

### 2. The Porous Glass Plates:

Regarding the porous glass plate as the active surface of the denuder, it is found that the roughness of glass plate is helpful for increasing the wettability of the absorption surface, the liquid film is observed uniformly and no more dry zone of the active surface occurs.

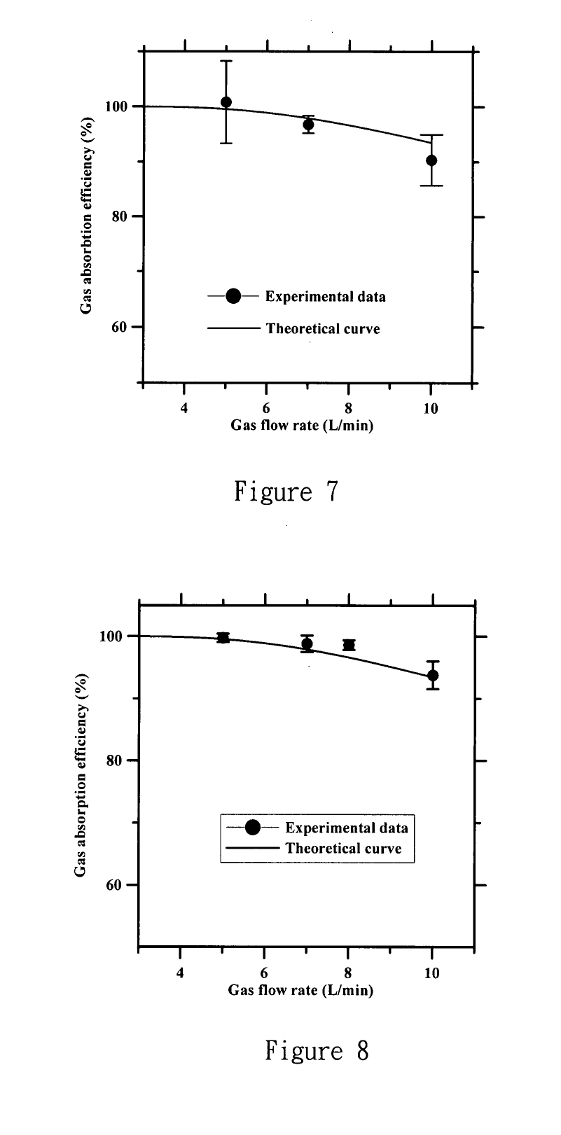

Regarding the gas absorption efficiency experimental result, the gas absorption efficiencies are 105.36%±9.06%, 96.76%±1.57% and 90.33%±4.6% when the gas flow rates are 5 L/min., 7 L/min. and 10 L/min., respectively. As can be seen in FIG. 7, the gas absorption efficiency approaches 100% which matches the design theory of a parallel plate wet denuder very well when the gas flow rate is 5 L/min. According to the calculation formulate presented by Gormley and Kennedy (1949), as shown in FIG. 7, which predicts the relationship of gas absorption efficiency versus different gas flow rates, is very coincided with the experimental data, the errors are all in the range of allowance.

### 3. The Task for Absorbing HCl Gas using the Parallel Plate Wet Denuder

According to the foregoing results and discussions, it can be concluded that the wettability of the porous glass plate used as the active surface is a good active surface, particularly the gas absorption efficiency reaches 100% when the gas flow rate of HF gas is 5 L/min.

For further ensuring the absorption efficiency for other acidic gases according to the present denuder, this experiment also performs the HCl gas absorption efficiency test as the comparative embodiment and shows the test results in FIG. 8. The gas absorption efficiencies are 99.75%±0.67, 98.80%±1.32, 98.6%±0.78 and 93.8±2.25 when the gas flow rates of HCl are 5 L/min., 7 L/min., 8 L/min. and 10 L/min., respectively. The results are reasonable and correspond to what are predicted in relevant theories.

Having illustrated and disclosed the preferred embodiments according to the present invention, those skilled in the art should appreciate that these embodiments did not limit the present invention, and numerous changes and modifications maybe made to these embodiments of the prevent invention, and that such changes and modifications may be made without departing from the spirit and scope of the present invention. Therefore, the protection scope of the present invention is defined by the appended claims.

### EXPLANATION OF MAIN COMPONENTS

1 Acrylic plate
2 Porous glass plate
3 Porous metal
4 Top reservoir
4a Liquid inlet
4b Exit of top reservoir
5 Bottom reservoir
5a Liquid outlet
5b Exit of bottom reservoir
6 Gas inlet
7 Gas outlet
8 Membrane
9 Polymeric sleeve
10 Poly carbonate membrane
11 Porous polyethylene film
12 Flow-evened filter paper
13 Glass plate
14 SiO₂-coated absorption surface
15 Nitrogen gas source
16 Air pump
17 Flow meter
18 Parallel plate denuder(PPD)
19 Mass flow controller(control valve)
20 Mass flow controller(power supply)
21 Permeation tube and oven
22 Scrubbing solution container
23 Peristaltic pump

We claim:

1. A parallel plate wet denuder assembled by two separated plates in parallel, top and bottom reservoirs arranged at the top and bottom portions of the plates respectively, and a gas channel between the two separated plates, characterized in that the two plates are glass plates with pore distribution.

2. The parallel plate wet denuder according to claim 1, wherein the two plates are treated by coating TiO₂ particles and being irradiated with UV light so as to induce a photo catalysis and enhance the hydrophilic property of the plates.

3. The parallel plate wet denuder according to claim 1, wherein the pore distribution of the glass plates is formed by controlling the pore size and depth during sandblasting, so that it makes the falling film even while the scrubbing liquid is flowing down.

4. The parallel plate wet denuder according to claim 2, wherein the irradiation of UV light could oxidize the oily residual of organic gases and regenerate the hydrophilic property of the plates.

5. The parallel plate wet denuder according to claim 1, wherein the top end of the plate further comprises a porous metal.

6. The parallel plate wet denuder according to claim 2, which is used as the absorption and oxidization equipment for oxidizing the oily residual of organic gases and regenerating the hydrophilic property of the plates.

7. A continuous sampling and analysis system, comprising: a parallel plate wet denuder according to claim 1, a transportation system for gas sampling and scrubbing liquid, and an analysis apparatus for analyzing the absorbed components of the scrubbing liquid; wherein the fresh scrubbing liquid is transferred into the parallel plate wet denuder via the transportation system, and reacts with the active components of the gases, and finally are transferred to the analysis apparatus where the absorbed components are analyzed continuously.

8. The continuous sampling and analysis system according to claim 7, wherein the two plates of the denuder are treated by coating TiO₂ particles and being irradiated with UV light so as to induce a photo catalytic reaction and enhance its hydrophilic property of the plates.

9. The continuous sampling and analysis system according to claim 7, wherein the analysis apparatus for analyzing the absorbed components of the scrubbing liquid is an ion chromatograph.

10. The continuous sampling and analysis system according to claim 7, wherein the operation for analyzing the absorbed components is manual.
